(19) United States
(12) Patent Application Publication
(10) Pub. No.: US 2026/0338562 A1
(43) Pub. Date: Oct. 29, 2026

(54) MEETING SUPPORT METHOD AND MEETING SUPPORT SYSTEM

(71) Applicant: NISSAN MOTOR CO., LTD., Yokohama-shi, Kanagawa (JP)

(72) Inventors: Ryuji KUROSAKI, Kanagawa (JP); Kenta SUZUKI, Kanagawa (JP)

(73) Assignee: NISSAN MOTOR CO., LTD., Yokohama-shi, Kanagawa (JP)

(21) Appl. No.: 19/486,310

(22) PCT Filed: May 22, 2023
(86) PCT No.: PCT/JP2023/018967

§ 371 Date: Nov. 20, 2025

(51) Int. Cl. G01C 21/34; G01C 21/36

(52) U.S. Cl. CPC G01C 21/3438; G01C 21/3676

(57) ABSTRACT

A meeting support method for displaying position information of one user on map information of a terminal of another user when the users are to meet at a specific location is provided. This meeting support method acquires the position information of the one user at a predetermined cycle, estimates a passage path between two locations on a map of the one user and calculates an estimated passage time between the two locations, and compares the estimated passage time with an actual passage time taken by the one user to pass between the two locations. Then, a trajectory of the estimated passage path is displayed on the terminal of the other user in a display mode according to a degree of delay or advance of the actual passage time with respect to the estimated passage time.

### TECHNICAL FIELD

The present invention relates to a meeting support method and a meeting support system.

### BACKGROUND ART

In the related art, a system is known in which when users meet at a specific location, position information of the user is acquired and displayed on a terminal in order to confirm whether a party is smoothly heading to the meeting location.

Patent Document 1 discloses a technique for supporting meeting by displaying a meeting place, a position of a user who is meeting, a path to the meeting place, and the like on a mobile terminal.

### PRIOR ART DOCUMENT

### Patent Document

Patent Document 1: JP 6221534 B

### SUMMARY OF INVENTION

When a cycle of acquiring position information of a user displayed on a terminal is long, another user (met party) cannot dynamically recognize movement of the position of the user, and it may be difficult to recognize whether the user is moving toward a meeting location as scheduled.

On the other hand, it is necessary to process a huge amount of data in order to acquire position information in a short cycle and display the position information on the terminal so that the position of the user can be dynamically grasped. Therefore, there is a possibility that an operation cost increases or a processing load of data communication is too heavy to grasp the position of the user in time.

The present invention has been made in view of the above problem, and an object of the present invention is to provide a meeting support method and a meeting support system capable of easily recognizing whether a user is moving as scheduled while reducing a data communication amount.

According to an aspect of the present invention, a meeting support method for displaying position information of one user on map information of a terminal of another user when the users are to meet at a specific location is provided. This meeting support method acquires the position information of the one user at a predetermined cycle, estimates a passage path between two locations on a map of the one user and calculates an estimated passage time between the two locations, and compares the estimated passage time with an actual passage time taken by the one user to pass between the two locations. Then, a trajectory of the estimated passage path is displayed on the terminal of the other user in a display mode according to a degree of delay or advance of the actual passage time with respect to the estimated passage time.

### BRIEF DESCRIPTION OF DRAWINGS

FIG. 1 is a schematic configuration diagram of a meeting support system according to each embodiment.

FIG. 2 is a diagram illustrating a user position information display screen in a terminal.

FIG. 3 is a diagram illustrating a user position information display screen according to a modification.

FIG. 4 is a diagram illustrating a user position information display screen according to a modification.

FIG. 5 is a diagram illustrating a user position information display screen according to a modification.

FIG. 6 is a sequence chart of a meeting support service.

FIG. 7 is a flowchart of a meeting support service program.

FIG. 8 is a diagram illustrating a user position information display screen according to a modification.

FIG. 9 is a position and time graph illustrating a meeting support system according to a modification of a first embodiment.

FIG. 10 is a diagram illustrating a pattern of a degree of delay or advance.

FIG. 11 is a diagram illustrating a user position information display screen in a meeting support system according to a third embodiment.

FIG. 12 is a diagram illustrating a user position information display screen in a meeting support system according to a fourth embodiment.

### DESCRIPTION OF EMBODIMENTS

Hereinafter, embodiments of the present invention will be described with reference to the drawings and the like.

### First Embodiment

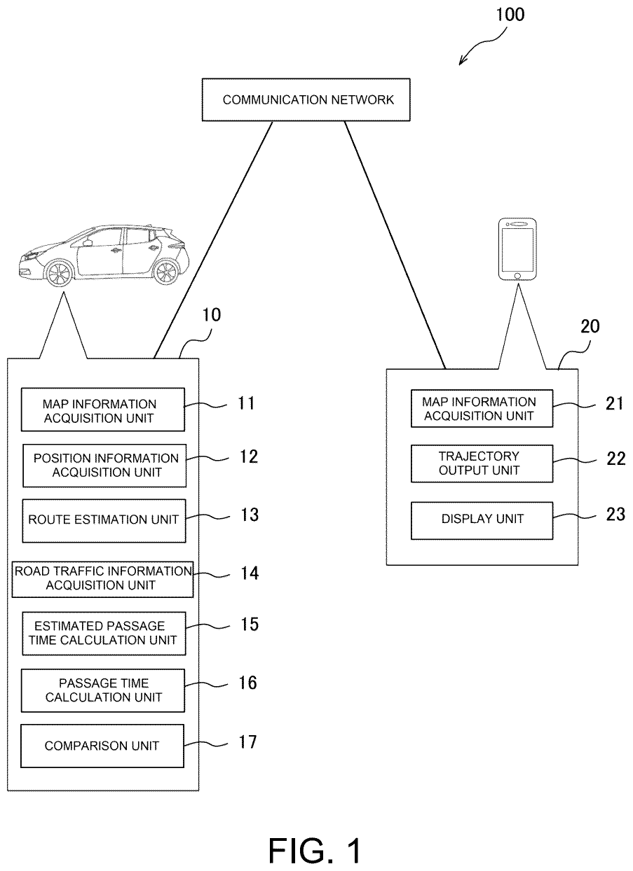

FIG. 1 is a block diagram illustrating a schematic configuration of a meeting support system 100 employing a meeting support method according to each embodiment of the present invention. The meeting support system 100 is a system that provides a meeting support service that displays position information of one user (hereinafter, also referred to as a first user) on map information of a terminal 20 of another user (hereinafter, also referred to as a second user) when the users meet at a specific location. In the present embodiment, it is assumed that the first user moves to a meeting place by a vehicle and the second user waits for the first user to arrive at the meeting place, but the present invention is not limited thereto.

As illustrated in FIG. 1, the meeting support system 100 includes an in-vehicle terminal 10 mounted in the vehicle ridden by the first user and the terminal (user terminal) 20 of the second user. The in-vehicle terminal 10 and the user terminal 20 are configured to communicate with each other via a communication network.

Each of the in-vehicle terminal 10 and the user terminal 20 includes one or a plurality of computers, and includes, for example, a central processing unit (CPU), a random access memory (RAM), and an input/output interface (I/O interface). The in-vehicle terminal 10 and the user terminal 20 are programmed to execute control related to the meeting support service as necessary.

The in-vehicle terminal 10 is an in-vehicle device mounted in the vehicle ridden by the first user, and provides position information of the first user to the terminal 20 of the second user. The in-vehicle terminal 10 includes a map information acquisition unit 11, a position information acquisition unit 12, a route estimation unit 13, a road traffic information acquisition unit 14, an estimated passage time calculation unit 15, a passage time calculation unit 16, and a comparison unit 17.

The map information acquisition unit 11 acquires map information from a map database (not illustrated) or an external server by communication. The map database may be included in a controller of a vehicle system in which the in-vehicle terminal 10 is mounted, or may be provided outside. The method of acquiring the map information is not limited to the above, and any known method may be used.

The position information acquisition unit 12 is, for example, a GPS receiver, receives a signal (GPS data) transmitted from a GPS satellite at a predetermined cycle, and detects (acquires) a position of the vehicle ridden by the first user (hereinafter, also referred to as position information of the first user) on the map information based on the received GPS data. The method of acquiring the position information of the first user is not limited to the above, and any known method may be used.

The route estimation unit 13 estimates a passage path between two locations between which the first user passes on the map. Here, the two locations between which the first user passes on the map are two locations including a previous position (hereinafter, also referred to as a previous position of the first user) and a current position (hereinafter, also referred to as a current position of the first user) on the map of the first user acquired by the position information acquisition unit 12 at the predetermined cycle. The route estimation unit 13 calculates, based on the map information, a route with shortest distance (shortest route) between the two locations between which the first user passes on the map, and estimates the shortest route as a path through which the first user passes. The route estimation unit 13 transmits the position information of the first user and the estimated passage path of the first user (hereinafter, also referred to as an estimated passage path) to the terminal 20.

The road traffic information acquisition unit 14 acquires road traffic information from the current position of the first user to a meeting location from an external server or the like that manages the road traffic information. The road traffic information includes road restrictions such as road closures and real time congestion information.

The estimated passage time calculation unit 15 calculates an estimated passage time between the two locations between which the first user passes on the map (hereinafter, also simply referred to as an estimated passage time) based on the passage path of the first user estimated by the route estimation unit 13 (estimated passage path) and the road traffic information acquired by the road traffic information acquisition unit 14. As described above, the two locations on the map through which the first user passes are the two locations including the previous position and the current position of the first user. If there is a road closure on the passage path estimated by the route estimation unit 13, the estimated passage time may be calculated after the estimation of the passage path is corrected.

The passage time calculation unit 16 calculates an actual passage time taken by the first user to pass (hereinafter, also simply referred to as an actual passage time) between the two locations between which the first user passes on the map. The passage time calculation unit 16 has, for example, a clock function, and calculates a time taken by the first user to pass between the two locations from a difference between a timing when the first user passes the previous position and a timing when the first user passes the current position. However, the method of calculating the passage time is not limited thereto.

The comparison unit 17 compares the estimated passage time calculated by the estimated passage time calculation unit 15 with the actual passage time calculated by the passage time calculation unit 16. For example, the comparison unit 17 calculates a difference between the estimated passage time and the actual passage time. The comparison unit 17 transmits the comparison result to the terminal 20.

The user terminal 20 is, for example, a mobile phone, a smartphone, or a tablet terminal owned by the second user, and includes a map information acquisition unit 21, a trajectory output unit 22, and a display unit 23.

The map information acquisition unit 21 acquires map information from a map database (not illustrated) or an external server by communication. The map database may be included in the terminal 20 or may be provided outside the terminal 20. The method of acquiring the map information is not limited to the above, and any known method may be used.

The trajectory output unit 22 receives the position information of the first user, the estimated passage path of the first user, and the comparison result between the estimated passage time and the actual passage time from the in-vehicle terminal 10, and displays the position information of the first user and the trajectory of the estimated passage path of the first user on the display unit 23. Here, the trajectory output unit 22 causes the trajectory of the estimated passage path to be displayed in a display mode according to a degree of delay or advance of the actual passage time with respect to the estimated passage time based on the comparison result between the estimated passage time and the actual passage time. Details of the display mode of the trajectory displayed on the display unit 23 by the trajectory output unit 22 will be described later.

The display unit 23 is a display that displays the position information of the first user. The display unit 23 displays, on the map information, the position information of the first user and the trajectory of the estimated passage path.

As described above, the meeting support system 100 displays the position information of the first user on the map information of the terminal 20 of the second user, so that the second user can confirm whether the first user is moving smoothly toward the meeting location.

When the cycle of acquiring the position information of the first user displayed on the terminal 20 of the second user is long, the second user cannot dynamically recognize the movement of the position of the first user, and it may be difficult to recognize whether the first user is moving toward the meeting location as scheduled.

On the other hand, in order to acquire the position information of the first user in such a short cycle that the position of the first user can be dynamically grasped and to display the position information on the terminal 20 of the second user, it is necessary to process a huge amount of data. Therefore, there is a possibility that an operation cost increases or a processing load of data communication is too heavy to grasp the position of the first user in time.

In this regard, in the present embodiment, the position information of the first user is displayed on the terminal 20 of the second user together with the trajectory of the estimated passage path of the first user. Accordingly, even if the cycle of acquiring the position information of the first user is long to some extent, the second user can dynamically recognize the movement of the position of the first user. In the present embodiment, the trajectory of the estimated passage path is displayed in the display mode according to the degree of delay or advance of the actual passage time with respect to the estimated passage time based on the comparison result between the estimated passage time and the actual passage time between the two locations between which the first user passes on the map. Accordingly, the second user can easily recognize whether the first user is moving toward the meeting location as scheduled. That is, by lengthening the cycle of acquiring the position information of the first user, the second user can easily recognize whether the first user is moving as scheduled while reducing a data communication amount.

Hereinafter, the display mode of the trajectory displayed on the user terminal 20 will be described in detail.

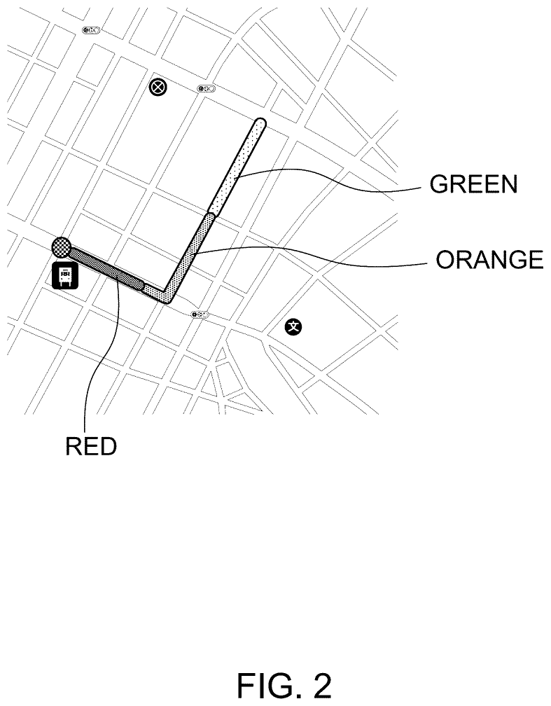

FIGS. 2 to 5 are diagrams illustrating user position information display screens on the display unit 23 of the user terminal 20.

As described above, the trajectory output unit 22 causes the display unit 23 to display the trajectory of the estimated passage path of the first user. The trajectory output unit 22 causes the display unit 23 to perform display by changing the display mode of the trajectory of the estimated passage path based on the comparison result obtained by the comparison unit 17 of the in-vehicle terminal 10. Specifically, the trajectory of the estimated passage path is displayed on the terminal 20 (display unit 23) by changing a color or shape according to the degree of delay or advance of the actual passage time with respect to the estimated passage time between the two locations between which the first user passes on the map (hereinafter, also simply referred to as the degree of delay or advance of the passage time).

For example, as illustrated in FIG. 2, the trajectory of the estimated passage path is displayed by changing a color type according to the degree of delay or advance of the passage time. Here, a plurality of different thresholds are set for the difference between the estimated passage time and the actual passage time, and the degree of delay or advance of the passage time is determined by comparing the difference between the estimated passage time and the actual passage time with the thresholds. For example, if a difference Δt between the estimated passage time and the actual passage time is Δt₋₂<Δt≤Δt₋₁, the degree of advance is determined to be the largest, if Δt₋₁<Δt<0, the degree of advance is determined to be a little, and if Δt=0, the degree of advance is determined to be smooth. Further, if 0<Δt≤Δt₁, it is determined that there is a small delay, and if Δt₁<Δt≤Δt₂, it is determined that the degree of delay is the largest (note that Δt₋₂<Δt₋₁<0<Δt₁<Δt₂). Hereinafter, the case of Δt₋₂<Δt≤Δt₋₁ is referred to as a “large advance”, the case of Δt₋₁<Δt<0 is referred to as a “small advance”, the case of Δt=0 is referred to as a “smooth advance”, the case of 0<Δt≤Δt₁ is referred to as the “small delay”, and the case of Δt₁<Δt≤Δt₂ is referred to as a “large delay”.

In FIG. 2, the case of the small advance or smooth advance is indicated by a green trajectory, the case of the small delay is indicated by an orange trajectory, and the case of the large delay is indicated by a red trajectory. The second user can easily recognize how much the first user is advancing or delaying compared with a schedule from the trajectory displayed on the terminal 20 and the color type of the trajectory.

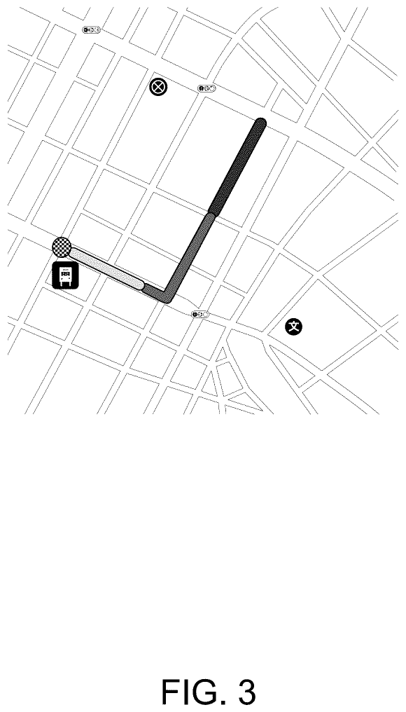

In FIG. 2, the color of the trajectory is changed according to the degree of delay or advance of the passage time, but for example, as illustrated in FIG. 3, a color shade of the trajectory may be changed according to the degree of delay or advance of the passage time. In FIG. 3, the case of the large delay is indicated by a darkest colored trajectory, the case of the small delay is indicated by a slightly darker colored trajectory, and the case of the smooth advance or small advance is indicated by a lighter colored trajectory. The second user can easily recognize how much the first user is advancing or delaying compared with the schedule from the trajectory displayed on the terminal 20 and the color shade of the trajectory.

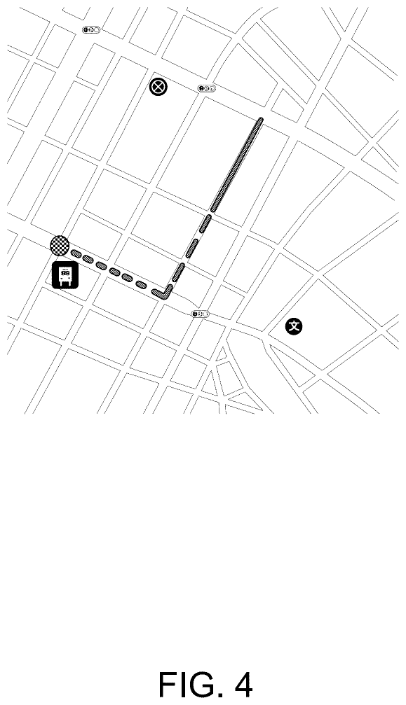

Further, a shape may be changed according to the degree of delay or advance of the passage time and displayed on the terminal 20. For example, as illustrated in FIG. 4, the trajectory of the estimated passage path may be indicated by a dotted line, and an interval of the dotted line may be changed according to the degree of delay or advance of the passage time. In FIG. 4, the interval of the dotted line is made large (substantially solid line) in the case of the small advance or smooth advance, the interval of the dotted line is made slightly large in the case of the small delay, and the interval of the dotted line is made the smallest in the case of the large delay. The second user can easily recognize how much the first user is advancing or delaying compared with the schedule from the trajectory displayed on the terminal 20 and the interval of the dotted line of the trajectory.

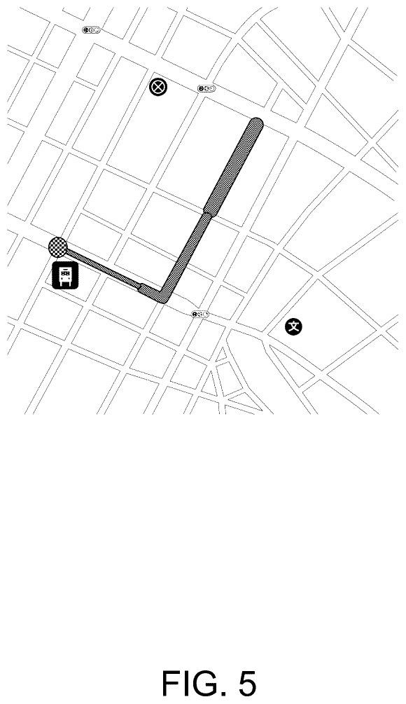

As illustrated in FIG. 5, a thickness of a line of the trajectory may be changed according to the degree of delay or advance of the passage time. In FIG. 5, the line of the trajectory is made thick in the case of the large delay, the line of the trajectory is made slightly thick in the case of the small delay, and the line of the trajectory is made thin in the case of the small advance or smooth advance. The second user can easily recognize how much the first user is advancing or delaying compared with the schedule from the thickness of the line of the trajectory displayed on the terminal 20.

Both the color and the shape of the trajectory may be changed according to the degree of delay or advance of the passage time. For example, as the delay becomes larger, the trajectory in a darker and thicker line may be displayed.

As described above, since the trajectory of the estimated passage path is displayed on the terminal 20 in the display mode according to the degree of delay or advance of the actual passage time with respect to the estimated passage time, the second user can easily recognize whether the first user is moving toward the meeting location as scheduled.

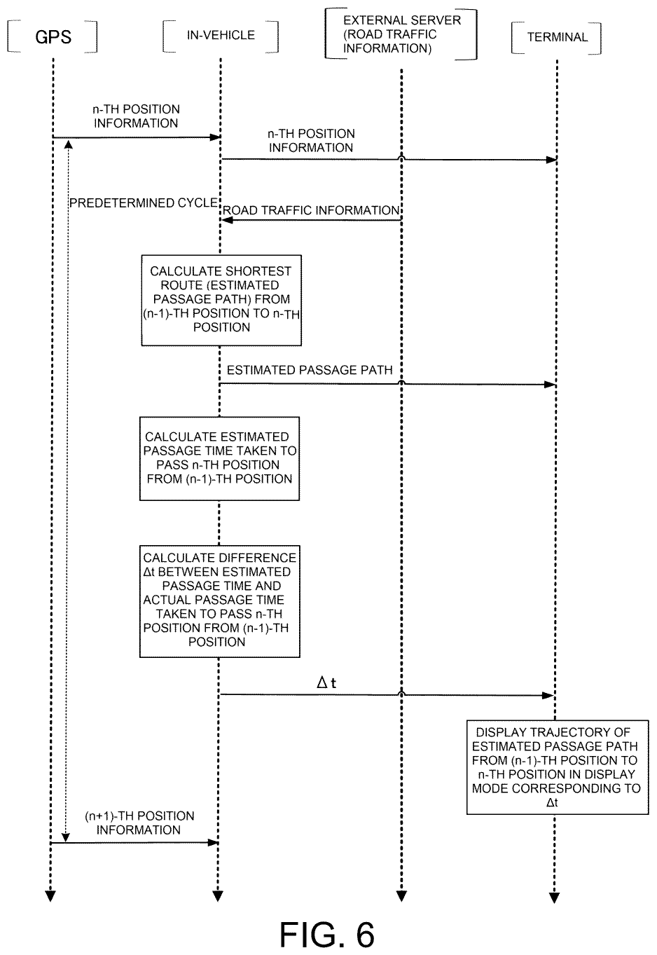

FIG. 6 is a sequence chart of the meeting support service.

The meeting support service is started when a system of the vehicle equipped with the in-vehicle terminal 10, an application related to the meeting support service of the user terminal 20, and the like are activated. However, the method of starting the meeting support service is not limited thereto.

When the meeting support service is started, the in-vehicle terminal 10 (position information acquisition unit 12) receives a signal from a GPS satellite at the predetermined cycle and acquires the position information of the first user at the predetermined cycle. Here, it is assumed that after an (n−1)-th position of the first user is acquired (omitted in FIG. 6), an n-th position of the first user is acquired after one cycle elapses. The in-vehicle terminal 10 (position information acquisition unit 12) transmits the acquired position information of the first user to the terminal 20.

When the position information of the first user is acquired, the in-vehicle terminal 10 (route estimation unit 13) calculates a route with shortest distance from the (n−1)-th position to the n-th position of the first user, and sets the route as the estimated passage path. The in-vehicle terminal 10 (route estimation unit 13) transmits the estimated passage path to the terminal 20.

In addition, the in-vehicle terminal 10 (road traffic information acquisition unit 14) appropriately acquires road traffic information including real time congestion information or the like from an external server or the like.

Next, the in-vehicle terminal 10 (estimated passage time calculation unit 15) calculates an estimated passage time until the first user passes the n-th position from the (n−1)-th position (estimated passage time) based on the estimated passage path and the road traffic information.

The in-vehicle terminal 10 (passage time calculation unit 16 and comparison unit 17) calculates an actual passage time taken by the first user to pass the n-th position from the (n−1)-th position (actual passage time), and calculates a difference Δt between the estimated passage time and the actual passage time.

The in-vehicle terminal 10 transmits n-th position information of the first user, the estimated passage path, and the difference Δt between the estimated passage time and the actual passage time to the terminal 20.

Upon receiving (n−1)-th and n-th position information of the first user, the estimated passage path, and the difference Δt between the estimated passage time and the actual passage time, the terminal 20 displays a trajectory of the estimated passage path from the (n−1)-th position to the n-th position of the first user. The terminal 20 displays the trajectory of the estimated passage path in a display mode according to the difference Δt between the estimated passage time and the actual passage time. Accordingly, the second user can easily recognize whether the first user is moving toward the meeting location as scheduled.

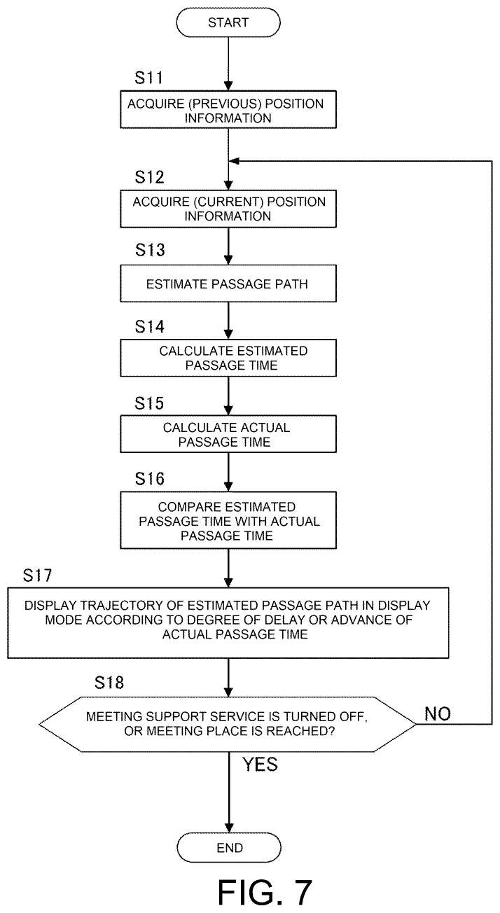

FIG. 7 is a flowchart of a meeting support service program. The following control is repeatedly executed every predetermined time interval by a program of a computer constituting the in-vehicle terminal 10 and the terminal 20. As described above, the in-vehicle terminal 10 appropriately acquires the road traffic information including the real time congestion information or the like from the external server or the like.

As described above, the meeting support service is started, for example, when the system of the vehicle equipped with the in-vehicle terminal 10 and the application related to the meeting support service of the terminal 20 are activated. The terminal 20 may be configured to set a meeting place on the map information of the terminal 20 at the start of the meeting support service.

When the meeting support service is started, in step S11, the in-vehicle terminal 10 acquires the position information of the first user. The position information acquired in step S11 is a previous position n−1.

After a predetermined time (one cycle) elapses, in step S12, the in-vehicle terminal 10 acquires the position information of the first user. The position information acquired in step S12 is a current position n.

In step S13, the in-vehicle terminal 10 estimates a passage path of the first user from the previous position n−1 to the current position n based on the map information. Specifically, the route with shortest distance from the previous position n−1 to the current position n is estimated as the path through which the first user passes.

In step S14, the in-vehicle terminal 10 calculates an estimated passage time for the first user to pass the n-th position from the (n−1)-th position (estimated passage time) based on the estimated passage path, and the road traffic information.

In step S15, the in-vehicle terminal 10 calculates an actual passage time taken by the first user to pass the n-th position from the (n−1)-th position (actual passage time).

In step S16, the in-vehicle terminal 10 compares the estimated passage time with the actual passage time. Specifically, the difference Δt between the estimated passage time and the actual passage time is calculated.

In step S17, the terminal 20 displays the trajectory of the estimated passage path from the (n−1)-th position to the n-th position of the first user on the map information in a display mode according to the difference Δt between the estimated passage time and the actual passage time, that is, the degree of delay or advance of the actual passage time with respect to the estimated passage time.

In step S18, if the meeting support service is turned off by the user or the meeting place is set in the terminal 20, the in-vehicle terminal 10 and the terminal 20 repeat the processing of steps S12 to S17 until the first user arrives at the meeting place.

In this way, in the present embodiment, since the terminal 20 displays the trajectory of the estimated passage path of the first user, the second user can dynamically recognize the movement of the position of the first user even if the cycle of acquiring the position information of the first user is long to some extent. In addition, since the trajectory is displayed in the display mode according to the degree of delay or advance of the actual passage time with respect to the estimated passage time, the second user can easily recognize whether the first user is moving toward the meeting location as scheduled.

According to the meeting support method and the meeting support system 100 of the first embodiment described above, the following effects can be obtained.

According to the meeting support method of the present embodiment, the position information of the one user (first user) is acquired at the predetermined cycle, the passage path between the two locations between which the one user (first user) passes on the map is estimated, the estimated passage time between the two locations is calculated, and the estimated passage time is compared with the actual passage time taken by the one user (first user) to pass between the two locations. Then, the trajectory of the estimated passage path is displayed on the terminal 20 of another user (second user) in the display mode according to the degree of delay or advance of the actual passage time with respect to the estimated passage time. As described above, since the trajectory of the estimated passage path between the two locations between which the one user (first user) passes is displayed on the terminal 20 of the other user (second user), the other user (second user) can dynamically recognize the movement of the position of the one user (first user) even if the cycle of acquiring the position information of the one user (first user) is lengthened to reduce the data communication amount. In addition, since the trajectory of the estimated passage path is displayed in the display mode according to the degree of delay or advance with respect to the estimated passage time, the other user (second user) can easily recognize whether the one user (first user) is moving as scheduled. That is, it is possible to easily recognize whether the user is moving as scheduled while reducing the data communication amount.

According to the meeting support method of the present embodiment, the passage path between two locations of the previous position and the current position of the one user (first user) on the map acquired at the predetermined cycle is estimated, and the trajectory of the estimated passage path is displayed on the terminal 20 of another user (second user). That is, the trajectory is displayed every predetermined cycle for acquiring position information of the one user (first user). Accordingly, the other user (second user) can recognize real time position and movement status of the one user (first user) each time the position information of the one user (first user) is updated, and can more accurately recognize whether the one user (first user) is moving as scheduled.

According to the meeting support method of the present embodiment, the road traffic information including the congestion information is acquired, and the estimated passage time between the two locations between which the one user (first user) passes on the map is calculated based on the road traffic information. Accordingly, the passage time between the two locations can be estimated more accurately than in a case where the estimated passage time is calculated without considering the congestion information. Therefore, the other user (second user) can more accurately recognize whether the one user (first user) is moving toward the meeting place as scheduled.

According to the meeting support method of the present embodiment, the degree of delay or advance of the actual passage time with respect to the estimated passage time is determined by comparing, with a plurality of different thresholds, the difference between the estimated passage time and the actual passage time between two locations between which the one user (first user) passes on the map. Accordingly, the degree of delay or advance of the actual passage time can be easily and clearly determined.

According to the meeting support method of the present embodiment, the trajectory of the estimated passage path of the one user (first user) is displayed on the terminal 20 of the other user (second user) by changing at least one of the color and the shape according to the degree of delay or advance of the actual passage time with respect to the estimated passage time. Accordingly, the other user (second user) can easily recognize whether the one user (first user) is moving as scheduled from the color and the shape of the trajectory displayed on the terminal 20.

The meeting support system 100 according to the present embodiment includes the position information acquisition unit 12 that acquires the position information of the one user (first user) at the predetermined cycle, the route estimation unit 13 that estimates the passage path between the two locations between which the one user (first user) passes on the map, the estimated passage time calculation unit 15 that calculates the estimated passage time between the two locations, and the comparison unit 17 that compares the estimated passage time with the actual passage time taken by the one user (first user) to pass between the two locations. In addition, the trajectory output unit 22 that displays the estimated trajectory of the passage path on the terminal 20 of the other user (second user) in the display mode according to the degree of delay or advance of the actual passage time with respect to the estimated passage time is provided. Accordingly, since the trajectory of the estimated passage path between the two locations between which the one user (first user) passes is displayed on the terminal 20 of the other user (second user), the other user (second user) can dynamically recognize the movement of the position of the one user (first user) even if the cycle of acquiring the position information of the one user (first user) is lengthened to reduce the data communication amount. In addition, since the trajectory of the estimated passage path is displayed in the display mode according to the degree of delay or advance with respect to the estimated passage time, the other user (second user) can easily recognize whether the one user (first user) is moving as scheduled. That is, it is possible to easily recognize whether the user is moving as scheduled while reducing the data communication amount.

In the present embodiment, the estimated passage time of the first user is calculated based on the road traffic information including the real time congestion information, but the present invention is not necessarily limited thereto. For example, the estimated passage time of the first user may be calculated by predicting congestion status with reference to a congestion database in which past congestion information is accumulated. The congestion database may be included in the controller of the vehicle in which the in-vehicle terminal 10 is mounted, or congestion database of an external server may be referred to. Further, for example, the estimated passage time may be calculated with reference to both the road traffic information including the real time congestion information and the congestion database. For example, the estimated passage time may be calculated only from a distance, a shape of a road, a speed limit, and the like without referring to the road traffic information and the congestion database.

In the present embodiment, the route with shortest distance between the two locations between which the first user passes on the map is set as the estimated passage path of the first user, but the present invention is not necessarily limited thereto. For example, a route with shortest time between the two locations may be set as the estimated passage path. In this case, the estimated passage path is calculated based on not only the map information but also the road traffic information.

In addition, it is preferable to display the trajectory of the estimated passage path between the two locations including the previous position and the current position of the first user on the terminal 20 (that is, the trajectory is displayed every predetermined cycle for acquiring the position information of the first user) such that the second user can recognize the position of the first user every time the position information of the first user is updated, but the present invention is not necessarily limited thereto. For example, a trajectory of an estimated passage path between two locations including a second-previous position and the current position of the first user may be displayed on the terminal 20 (that is, the trajectory may be displayed every two cycles). In this case, the estimated passage time and the actual passage time compared by the comparison unit 17 are the estimated passage time and the actual passage time between the two locations including the second-previous position and the current position of the first user.

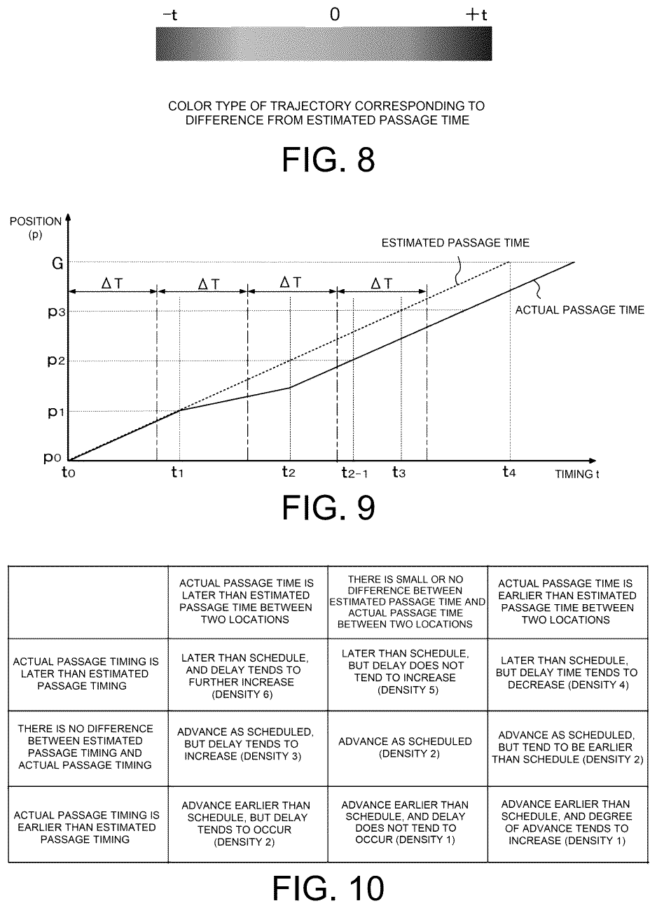

In the present embodiment, the degree of delay or advance of the actual passage time with respect to the estimated passage time is determined by comparing the difference between the estimated passage time and the actual passage time with a plurality of different thresholds, and the trajectory is displayed on the terminal 20 in the display mode according to the degree of delay or advance, but the present invention is not necessarily limited thereto. For example, the display mode of the trajectory may be continuously changed according to the difference between the estimated passage time and the actual passage time without setting the thresholds. For example, the color type of the trajectory may be determined with reference to a map in which the color type continuously changes according to the difference between the estimated passage time and the actual passage time, as illustrated in FIG. 8.

In the present embodiment, the in-vehicle terminal 10 includes the route estimation unit 13, the road traffic information acquisition unit 14, the estimated passage time calculation unit 15, the passage time calculation unit 16, and the comparison unit 17, and the user terminal 20 includes the trajectory output unit 22, but the present invention is not necessarily limited thereto. These configurations may be included in either the in-vehicle terminal 10 or the user terminal 20, or may be included in an external server capable of communicating with the in-vehicle terminal 10 and the user terminal 20.

### (Modification of First Embodiment)

A meeting support method and the meeting support system 100 according to a modification of the first embodiment will be described with reference to FIG. 9. Note that the same elements as those in the first embodiment are denoted by the same reference numerals, and the descriptions thereof will be omitted.

The basic configuration of the meeting support system 100 according to the present modification is the same as that of the first embodiment, but the present modification is different from the first embodiment in that the route estimation unit 13 estimates a passage path between two locations between which the first user will pass on a map.

In the present modification, the map information acquisition unit 11, the position information acquisition unit 12, the road traffic information acquisition unit 14, and the passage time calculation unit 16 of the in-vehicle terminal 10 and the map information acquisition unit 21 and the display unit 23 of the terminal 20 have the same functions as those of the first embodiment, and thus the descriptions thereof will be omitted.

The route estimation unit 13 in the meeting support system 100 of the present modification estimates a path to a meeting location G of the first user at a timing of departure of the first user or at a timing when the meeting support service is started (hereinafter, referred to as a timing of the departure or the like). In the present modification, it is assumed that the first user moves to the meeting location G along the path estimated by the route estimation unit 13.

The estimated passage time calculation unit 15 calculates the estimated passage time (timing) at positions (p₁, p₂, p₃) at each predetermined interval on the path estimated by the route estimation unit 13, thereby calculating an estimated passage time between the two locations of the positions (p₁, p₂, p₃) at each predetermined interval (between two locations on the map: between p₀ and p₁, between p₁ and p₂, and between p₂ and p₃). That is, as illustrated in FIG. 9, at a timing t₀ of the departure of the first user or the like, the route estimation unit 13 and the estimated passage time calculation unit 15 estimate the path t₀ the meeting location G of the first user (the passage path from the position p₀ to the position p₁, from the position p₁ to the position p₂, from the position p₂ to the position p₃, and from the position p₃ to the location G at each predetermined interval) and passage timings (t₁, t₂, t₃, and t₄) at the positions (p₁, p₂, p₃, and G) at each predetermined interval.

The comparison unit 17 compares the estimated passage time between the two locations (p₀ to p₁, p₁ to p₂, and p₂ to p₃) at the positions at each predetermined interval with the actual passage time taken by the first user to pass between the two locations.

A timing when the position information acquisition unit 12 acquires the position information of the first user does not necessarily match the passage timings (t₁, t₂, t₃) at the positions (p₁, p₂, p₃) at each predetermined interval estimated by the estimated passage time calculation unit 15. For example, in FIG. 9, when a cycle at which the position information acquisition unit 12 acquires the position information of the first user is set as AT, the timing when the position information acquisition unit 12 acquires the position information of the first user does not match the passage timing (t₁, t₂, t₃) estimated by the estimated passage time calculation unit 15. In this case, the actual passage time (timing) of the first user at the position (p₁, p₂, p₃) at each predetermined interval is calculated by interpolation based on the estimated passage timing (t₁, t₂, t₃) at each position (p₀, p₁, p₂, p₃) estimated at the timing of the departure or the like.

The trajectory output unit 22 receives the position information of the first user, the estimated passage path of the first user, and the comparison result between the estimated passage time and the actual passage time from the in-vehicle terminal 10, and causes the display unit 23 to display the position information of the first user and the trajectory of the estimated passage path of the first user. The trajectory output unit 22 displays the estimated trajectory of the passage path on the terminal 20 of the second user in the display mode according to the degree of delay or advance of the actual passage time with respect to the estimated passage time. In FIG. 9, the estimated passage time from the location p₀ to the location p₁ at the time of the departure or the like matches the actual passage time of the first user, but the actual passage time of the first user is delayed with respect to the estimated passage time from the location p₁ to the location p₂. On the other hand, the estimated passage time matches the actual passage time of the first user (slopes in graphs are equal) from the location p₂ to the location p₃. Therefore, trajectories from p₀ to p₁ and from p₂ to ps are displayed on the terminal 20 in a display mode indicating the movement as scheduled, and a trajectory from p₁ to p₂ is displayed on the terminal 20 in a display mode indicating a delay. The display mode of the trajectory displayed on the terminal 20 is the same as that of the first embodiment.

As described above, in the meeting support method of the present modification, the passage path between the two locations between which the one user (first user) passes on the map is estimated, the estimated passage time between the two locations is calculated, and the estimated passage time is compared with the actual passage time taken by the one user (first user) to pass between the two locations. Then, the trajectory of the estimated passage path is displayed on the terminal 20 of the other user (second user) in the display mode according to the degree of delay or advance of the actual passage time with respect to the estimated passage time. Also in the present modification, similarly to the first embodiment, since the trajectory of the estimated passage path between the two locations between which the one user (first user) passes is displayed on the terminal 20 of the other user (second user), the other user (second user) can dynamically recognize the movement of the position of the one user (first user) even if the cycle of acquiring the position information of the one user (first user) is lengthened to reduce the data communication amount. In addition, since the trajectory of the estimated passage path is displayed in the display mode according to the degree of delay or advance with respect to the estimated passage time, the other user (second user) can easily recognize whether the one user (first user) is moving as scheduled. That is, it is possible to easily recognize whether the user is moving as scheduled while reducing the data communication amount.

As described in the first embodiment and the modification of the first embodiment above, the passage path between the two locations on the map of the first user estimated by the route estimation unit 13 may be a passage path between the two locations between which the first user passes on the map, or may be a passage path between the two locations between which the first user will pass (in the future) on the map.

### Second Embodiment

A meeting support method and the meeting support system 100 according to a second embodiment will be described with reference to FIG. 10. The same elements as those in the first embodiment and the modification of the first embodiment are denoted by the same reference numerals, and the descriptions thereof will be omitted.

The meeting support method according to the second embodiment is different from the first embodiment in that the estimated trajectory of the passage path of the first user is displayed on the terminal of the other user in a display mode according to the degree of delay or advance of the actual passage time with respect to the estimated passage time between the two locations on the map and a degree of delay or advance of an actual passage timing with respect to the estimated passage timing between the two locations on the map.

In the present embodiment, the map information acquisition unit 11, the position information acquisition unit 12, the road traffic information acquisition unit 14, and the passage time calculation unit 16 of the in-vehicle terminal 10 and the map information acquisition unit 21 and the display unit 23 of the terminal 20 have the same functions as those of the first embodiment, and thus the descriptions thereof will be omitted.

In the meeting support system 100 according to the second embodiment, similar to the modification of the first embodiment, the route estimation unit 13 estimates a path to the meeting location G of the first user at the timing of the departure of the first user or at the timing when the meeting support service is started (the timing of the departure or the like). Also in the present embodiment, it is assumed that the first user moves to the meeting location G along the path estimated by the route estimation unit 13.

The estimated passage time calculation unit 15 calculates the estimated passage timings (t₁, t₂, t₃) at the positions (p₁, p₂, p₃) at each predetermined interval on the path estimated by the route estimation unit 13 and the estimated passage time between each two locations (each two locations on the map) of the positions (p₁, p₂, p₃) at each predetermined interval.

The comparison unit 17 compares the estimated passage time between the two locations (p₀ to p₁, p₁to p₂, and p₂ to p₃) at the positions at each predetermined interval with the actual passage time taken by the first user to pass between the two locations. The comparison unit 17 further compares the estimated passage timing (t₁, t₂, t₃) with the timing when the first user actually passes the position (p₁, p₂, p₃) at each predetermined interval.

The trajectory output unit 22 displays the estimated trajectory of the passage path on the terminal 20 of the second user in the display mode according to the degree of delay or advance of the actual passage timing of the first user with respect to the estimated passage timing and the degree of delay or advance of the actual passage time with respect to the estimated passage time. Specifically, the trajectory is divided into nine patterns shown in FIG. 10, and the trajectories are displayed in display modes corresponding to the respective patterns.

First, in a case where the actual passage timing of the first user is later than the estimated passage timing at the position at each predetermined interval estimated at the timing of the departure of the first user or the like, as described below, the trajectory is displayed in a mode indicating that the first user is later than the schedule.

In a case where the actual passage timing of the first user is later than the estimated passage timing at the position at each predetermined interval estimated at the timing of the departure of the first user or the like and the actual passage time taken by the first user to pass between two locations on the map is later than the estimated passage time between the two locations, the trajectory output unit 22 displays the trajectory in a display mode with a largest degree of delay. For example, at the location p₂ in FIG. 9, an actual passage timing t₂₋₁ of the first user is later than an estimated passage timing t₂, and an actual passage time t₂₋₁ to t₁ of the first user between p₁ and p₂ is later than an estimated passage time t₂ to t₁. Therefore, the trajectory output unit 22 displays the trajectory between p₁ and p₂ in the display mode with the largest degree of delay. For example, the trajectory output unit 22 displays the trajectory between p₁ and p₂ by a trajectory in a darkest color (for example, a color closest to red. Density 6). Accordingly, the second user can easily recognize that the first user is later than the schedule and the delay tends to further increase.

In a case where the actual passage timing of the first user is later than the estimated passage timing at the position at each predetermined interval estimated at the timing of the departure of the first user or the like, but if there is a small difference (or there is no difference) between the estimated passage time between the two locations on the map and the actual passage time taken by the first user to pass between the two locations, the trajectory output unit 22 displays the trajectory in a display mode with a second largest degree of delay. For example, at the location p₃ in FIG. 9, an actual passage timing t₃₋₁ of the first user is later than an estimated passage timing t₃, but an actual passage time t₃₋₁ to t₂ of the first user between p₂ and p₃ is not different from an estimated passage time t₃ to t₂. Therefore, the trajectory output unit 22 displays the trajectory between p₂ and p₃ in the display mode with the second largest degree of delay. For example, the trajectory output unit 22 displays the trajectory between p₂ and p₃ by a trajectory in a second darkest color (for example, a color second closest to red. Density 5). Accordingly, the second user can easily recognize that the first user is later than the schedule but the delay does not tend to increase.

In a case where the actual passage timing of the first user is later than the estimated passage timing at the position at each predetermined interval estimated at the timing of the departure of the first user or the like, but the actual passage time taken by the first user to pass between the two locations on the map is earlier than the estimated passage time between the two locations, the trajectory output unit 22 displays the trajectory in a display mode with a small degree of delay. In this case, for example, the trajectory output unit 22 displays the trajectory by a trajectory in a third darkest color (for example, a color third closest to red. Density 4). Accordingly, the second user can easily recognize that the first user is later than the schedule, but a delay time tends to decrease.

In addition, in a case where there is no difference between the estimated passage timing at the position at each predetermined interval estimated at the timing of the departure of the first user or the like and the actual passage timing of the first user, but the actual passage time taken by the first user to pass between the two locations on the map is later than the estimated passage time between the two locations, the trajectory output unit 22 displays the trajectory in a display mode indicating a tendency for delay. That is, in this case, the degree of delay is zero (advancing as scheduled) at present, but a delay occurs between two nearest locations. Therefore, since the delay of the first user tends to increase and there is a possibility that the first user cannot arrive at the meeting location as scheduled (may delay), the trajectory output unit 22 displays the trajectory in a fourth darkest color (for example, a color fourth closest to red. Density 3), for example. Accordingly, the second user can easily recognize that the first user is currently advancing as scheduled but the delay tends to increase.

On the other hand, if it is predicted that the first user will arrive at the meeting location at the timing as scheduled (advance as scheduled), the trajectory output unit 22 displays the trajectory in a mode indicating that the degree of delay is small or zero.

In a case where there is no difference between the estimated passage timing at the position at each predetermined interval estimated at the timing of the departure of the first user or the like and the actual passage timing of the first user, and there is a small difference (or no difference) between the estimated passage time between the two locations on the map and the actual passage time taken by the first user to pass between the two locations, it can be said that the first user is advancing as scheduled. For example, at the location p₁ in FIG. 9, there is no difference between the actual passage timing and the estimated passage timing (both are t₁) of the first user, and there is no difference between the actual passage time and the estimated passage time of the first user between p₀ and p₁ (both are t₁ to t₀). Therefore, the trajectory output unit 22 displays the trajectory between p₀ and p₁ in a mode indicating that the first user is advancing as scheduled. For example, the trajectory output unit 22 displays the trajectory between p₂ and p₃ by a trajectory in a light color (for example, a color slightly far from red. Density 2). Accordingly, the second user can easily recognize that the first user is advancing as scheduled.

Also in a case where there is no difference between the estimated passage timing at the position at each predetermined interval estimated at the timing of the departure of the first user and the actual passage timing of the first user, and the actual passage time taken by the first user to pass between two locations on the map is earlier than the estimated passage time between the two locations, the trajectory output unit 22 displays the trajectory in a display mode indicating that the first user is advancing as scheduled. In this case, the first user advances earlier than scheduled between two nearest locations, but is currently advancing as scheduled, and thus the trajectory output unit 22 displays, for example, the trajectory in a light color (for example, a color slightly far from red. Density 2). Accordingly, the second user can easily recognize that the first user is advancing as scheduled.

Also in a case where the actual passage timing of the first user is earlier than the estimated passage timing at the position at each predetermined interval estimated at the timing of the departure of the first user or the like, but the actual passage time taken by the first user to pass between two locations on the map is later than the estimated passage time between the two locations, it is expected that the first user will arrive at the meeting location at the timing as scheduled. In this case, the first user is currently advancing earlier than the schedule, but since a delay occurs between two nearest locations, the difference between the estimated passage timing and the actual passage timing of the first user tends to decrease. Therefore, the trajectory output unit 22 displays the trajectory in a display mode indicating the advance as scheduled. The trajectory output unit 22 displays, for example, the trajectory in a light color (for example, a color slightly far from red. Density 2).

If it is predicted that the first user will arrive at the meeting location earlier than a scheduled timing (the first user is advancing earlier than the schedule), the trajectory output unit 22 displays the trajectory in a mode indicating the advance earlier than the schedule.

In a case where the actual passage timing of the first user is earlier than the estimated passage timing at the position at each predetermined interval estimated at the timing of the departure of the first user or the like, and there is a small difference (or no difference) between the estimated passage time between two locations on the map and the actual passage time taken by the first user to pass between the two locations, it is expected that the first user will arrive at the meeting location earlier than the schedule. That is, in this case, there is a high possibility that the first user will arrive at the meeting location earlier because the first user is currently advancing earlier than the schedule and is advancing at the time as scheduled between two nearest locations. Therefore, the trajectory output unit 22 displays the trajectory in the mode indicating the advance earlier than the schedule. The trajectory output unit 22 displays, for example, the trajectory in a lightest color (for example, a color farthest from red. Density 1).

In a case where the actual passage timing of the first user is earlier than the estimated passage timing at the position at each predetermined interval estimated at the timing of the departure of the first user or the like, and the actual passage time taken by the first user to pass between two locations on the map is earlier than the estimated passage time between the two locations, it is also expected that the first user will arrive at the meeting location earlier than the schedule. That is, in this case, since the first user is currently advancing earlier than the schedule and is also advancing earlier than the schedule between two nearest locations, the degree of advance tends to increase, and there is a high possibility that the first user will arrive at the meeting location earlier. Therefore, the trajectory output unit 22 displays the trajectory in the mode indicating the advance earlier than the schedule. The trajectory output unit 22 displays, for example, the trajectory in the lightest color (for example, a color farthest from red. Density 1).

As described above, in the present embodiment, display is performed on the terminal of the other user in the display mode according to the degree of delay or advance at the actual passage timing of the first user with respect to the estimated passage timing and the degree of delay or advance of the actual passage time of the first user with respect to the estimated passage time between the two locations on the map. Accordingly, the second user can easily recognize whether the first user is likely to be late for a meeting timing, and whether the delay is likely to increase. For example, in the example of FIG. 10, it can be seen that the higher the density, the higher the possibility that the first user is late, and in the case of the density 4 to 6, it can be seen that the first user is likely to be later than the schedule. The second user can recognize whether the delay further increases or decreases by distinguishing between the density 6 and the density 4. Similarly, by distinguishing between the density 3 and the density 2, the second user can recognize whether the first user has a high possibility of arriving as scheduled (in the case of the density 2) or may be late (in the case of the density 3). Similarly, by distinguishing between the density 2 and the density 1, the second user can recognize whether the first user is likely to arrive at the meeting location earlier than the schedule.

In the present embodiment, the density (shade) is displayed in six levels to display the trajectory, but the present invention is not limited thereto. For example, different levels of the density may be set for the nine patterns illustrated in FIG. 10 (that is, the density may be divided into nine levels) to display the trajectory.

In the present embodiment, the density (shade) of the trajectory is changed according to the degree of delay or advance of the first user, but the present invention is not limited thereto. For example, as described in the first embodiment, the color, the shape, the thickness, and the like of the trajectory may be changed.

### Third Embodiment

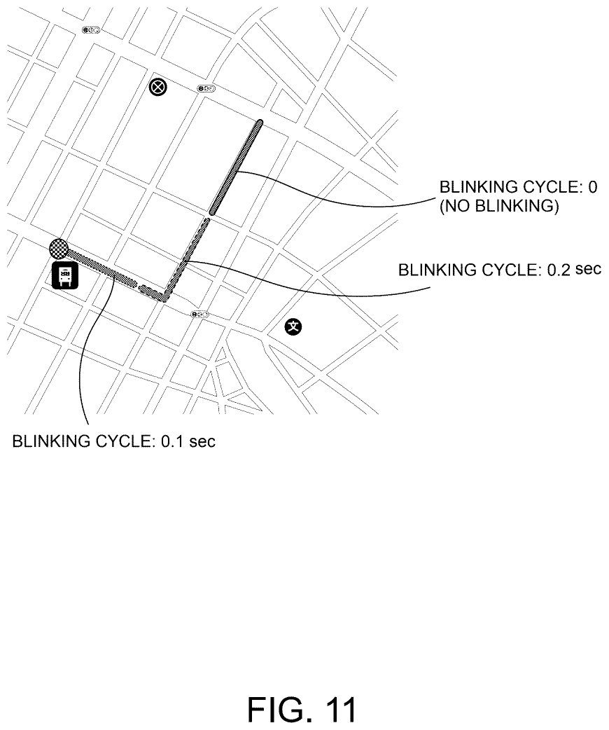

A meeting support method and the meeting support system 100 according to the third embodiment will be described with reference to FIG. 11. Note that the same elements as those in the first embodiment are denoted by the same reference numerals, and the descriptions thereof will be omitted.

FIG. 11 is a diagram illustrating a user position information display screen of the terminal 20 (display unit 23) in the meeting support system 100 according to a third embodiment. In the present embodiment, the display mode of the trajectory of the estimated passage path of the first user is different from that in other embodiments.

As illustrated in FIG. 11, in the present embodiment, the trajectory of the estimated passage path of the first user is displayed on the terminal 20 of the second user by different animations according to the degree of delay or advance of the actual passage time with respect to the estimated passage time.

Specifically, in the present embodiment, the trajectory of the estimated passage path of the first user is displayed on the terminal 20 in a blinking mode. A blinking cycle varies according to the degree of delay or advance of the actual passage time with respect to the estimated passage time of the first user.

For example, the difference Δt between the estimated passage time and the actual passage time is Δt=0, the blinking cycle is set to 0 (that is, no blinking), if 0<Δt≤Δt₁ (small delay), the blinking cycle is set to 0.2 sec, and if Δt₁<Δt≤Δt₂ (large delay), the blinking cycle is set to 0.1 sec. In this way, the second user can easily recognize whether the first user is moving as scheduled by shortening the blinking cycle as the degree of delay of the actual passage time increases.

As described above, instead of changing the blinking cycle by comparison with a threshold, the blinking cycle may be continuously changed according to the difference between the estimated passage time and the actual passage time.

In the present embodiment, the blinking cycle is changed according to the degree of delay or advance of the actual passage time with respect to the estimated passage time of the first user, but the present invention is not limited thereto. That is, the trajectory of the estimated passage path of the first user may be displayed on the terminal 20 by different animations according to the degree of delay or advance of the actual passage time with respect to the estimated passage time, and the second user can easily recognize whether the first user is moving as scheduled from a difference in the animations.

### Fourth Embodiment

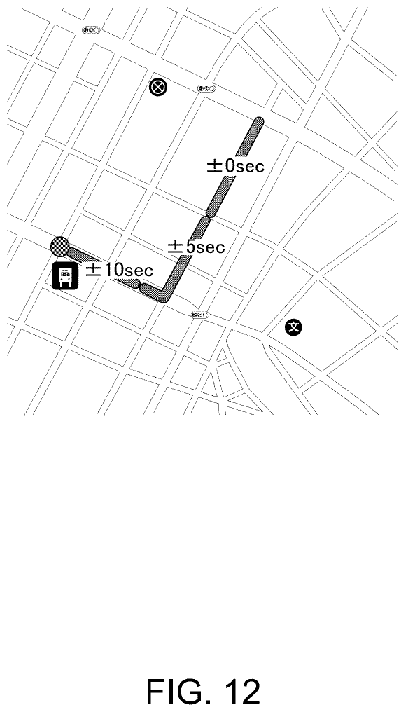

A meeting support method and the meeting support system 100 according to the fourth embodiment will be described with reference to FIG. 12. Note that the same elements as those in other embodiments are denoted by the same reference numerals, and the descriptions thereof will be omitted.

FIG. 12 is a diagram illustrating a user position information display screen of the terminal 20 (display unit 23) in the meeting support system 100 according to a fourth embodiment. In the present embodiment, the display mode of the trajectory of the estimated passage path of the first user is different from other embodiments.

As illustrated in FIG. 12, in the present embodiment, the trajectory of the estimated passage path of the first user displayed on the terminal 20 of the second user includes display of a difference between the estimated passage time and the actual passage time, such as ±0 sec, +5 sec, and +10 sec. As described above, since the trajectory of the estimated passage path includes the display of the difference between the estimated passage time and the actual passage time, the second user can easily recognize the degree of delay or advance of the first user, and can easily recognize whether the first user is moving as scheduled.

In any of the embodiments, in a case where a meeting place is set, an expected arrival timing of the first user at a meeting location, congestion information to a meeting location, route information to a meeting location, and the like may be displayed on the terminal 20 together with the trajectory of the estimated passage path of the first user. Accordingly, the second user can recognize not only whether the first user is moving toward the meeting location as scheduled but also whether the first user can move as scheduled in the future. In addition to the trajectory of the estimated passage path of the first user, an average moving speed of the first user, a predicted position of the first user when communication is interrupted due to a tunnel or the like, and the like may be displayed on the terminal 20. Accordingly, the second user can recognize in more detail whether the first user is moving as scheduled. Any one, or a part or all of the expected arrival timing, the congestion information, the route information, the average moving speed, and the predicted position may be displayed on the terminal 20.

Although the embodiments of the present invention have been described above, the above embodiments merely exemplify some of application examples of the present invention and do not intend to limit the technical scope of the present invention to the specific configurations of the above embodiments.

Each of the above-described embodiments has been described as a single embodiment, but may be appropriately combined.

For example, the trajectory may be displayed by changing the color type (first embodiment) and the blinking cycle (third embodiment) according to the degree of delay or advance of the actual passage time of the first user, or the color shade of the trajectory (first embodiment) may be changed and the difference between the estimated passage time and the actual passage time (fourth embodiment) may be displayed. That is, the modes of the trajectories described in the embodiments can be freely combined.

1. A meeting support method for displaying position information of one user on map information of a terminal of another user when the users are to meet at a specific location, the meeting support method comprising:
acquiring the position information of the one user at a predetermined cycle;
estimating a passage path between two locations on a map of the one user and calculating an estimated passage time between the two locations;
comparing the estimated passage time with an actual passage time taken by the one user to pass between the two locations; and
displaying a trajectory of the estimated passage path on the terminal of the other user in a display mode according to a degree of delay or advance of the actual passage time with respect to the estimated passage time.

2. The meeting support method according to claim 1, further comprising:
estimating a passage timing when the one user passes between the two locations;
comparing the estimated passage timing with a timing when the one user actually passes between the two locations; and
displaying the trajectory of the estimated passage path on the terminal of the other user in a display mode according to a degree of delay or advance of the timing when the one user actually passes with respect to the estimated passage timing and the degree of delay or advance of the actual passage time with respect to the estimated passage time between the two locations.

3. The meeting support method according to claim 1, wherein
the two locations on the map are two locations including a previous position and a current position on the map of the one user acquired at the predetermined cycle.

4. The meeting support method according to claim 1, further comprising:
acquiring road traffic information including congestion information, wherein
the estimated passage time between the two locations is calculated based on the road traffic information.

5. The meeting support method according to claim 1, further comprising:
by comparing a difference between the estimated passage time and the actual passage time with a plurality of different thresholds,
determining the degree of delay or advance of the actual passage time with respect to the estimated passage time.

6. The meeting support method according to claim 1, wherein
the trajectory is displayed on the terminal by changing at least one of a color and a shape according to the degree of delay or advance of the actual passage time with respect to the estimated passage time.

7. The meeting support method according to claim 6, wherein
the trajectory is displayed on the terminal by changing at least one of a color type and a color shade according to the degree of delay or advance of the actual passage time with respect to the estimated passage time.

8. The meeting support method according to claim 6, wherein
the trajectory is displayed on the terminal by changing a thickness of a line according to the degree of delay or advance of the actual passage time with respect to the estimated passage time.

9. The meeting support method according to claim 6, wherein
the trajectory is displayed on the terminal by a dotted line, and an interval of the dotted line varies according to the degree of delay or advance of the actual passage time with respect to the estimated passage time.

10. The meeting support method according to claim 1, wherein
the trajectory is displayed on the terminal by different animations according to the degree of delay or advance of the actual passage time with respect to the estimated passage time.

11. The meeting support method according to claim 10, wherein
the trajectory is displayed on the terminal in a blinking mode, and a blinking cycle varies according to the degree of delay or advance of the actual passage time with respect to the estimated passage time.

12. The meeting support method according to claim 1, further comprising:
displaying, together with the trajectory on the terminal, at least one of an expected arrival timing of the one user at a meeting location, congestion information to a meeting location, route information to a meeting location, and an average moving speed of the one user.

13. The meeting support method according to claim 1, wherein
the display of the trajectory includes displaying a difference between the estimated passage time and the actual passage time.

14. A meeting support system that displays position information of one user on map information of a terminal of another user when the users are to meet at a specific location, the meeting support system comprising:
a map information acquisition unit configured to acquire the map information;
a position information acquisition unit configured to acquire the position information of the one user at a predetermined cycle;
a route estimation unit configured to estimate a passage path between two locations on a map of the one user;
an estimated passage time calculation unit configured to calculate an estimated passage time between the two locations of the one user;
a passage time calculation unit configured to calculate an actual passage time taken by the one user to pass between the two locations;
a comparison unit configured to compare the estimated passage time with the actual passage time; and
a trajectory output unit configured to display a trajectory of the passage path estimated by the route estimation unit on the terminal of the other user in a display mode according to a degree of delay or advance of the actual passage time with respect to the estimated passage time.
